(19) United States
(12) Patent Application Publication
(10) Pub. No.: US 2002/0191184 A1
(43) Pub. Date: Dec. 19, 2002

(54) Method and device for detection of a translucent area or object by a light barrier

(76) Inventor: Wolfgang Eberhard Luxem, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/151,267

(22) Filed: May 20, 2002

(30) Foreign Application Priority Data
Jun. 14, 2001 (DE) 101 28 557.4

(51) Int. Cl. G01N 21/00; G01J 4/00

(52) U.S. Cl. 356/369; 356/432

(57) ABSTRACT

A method and device for detecting a more opaque area or object in comparison with a translucent area or object, preferably for the detection of a stock or substrate on a transparent conveyor belt, by a light barrier. Reflection losses are preferably prevented, so that the light of the light barrier, which shines at least approximately under the Brewster (polarizing) angle on the translucent area or object, is used.

### FIELD OF THE INVENTION

The invention relates to a method and device for the detection of a more opaque area or object in comparison with a translucent area or object, preferably for the detection of a stock or substrate on a transparent conveyor belt, by a light barrier.

### BACKGROUND OF THE INVENTION

It is customary, particularly for the detection of a sheet to be printed on a transparent conveyor belt in a printing press, especially an electrophotographic printing press, to use a light barrier, which passes through and refracts the transparent conveyor belt as soon as a sheet stock or substrate to be printed enters its ray path. For this purpose, a light source and a light receiver can be arranged so that they are facing each other on different sides of the conveyor belt, but the light source and the light receiver may also be combined on the same side to form a sensor device, and a light reflector may be arranged on the other side of the conveyor belt. In the first arrangement mentioned, the light would pass through the conveyor belt once, while in the second arrangement mentioned, the light would pass through the conveyor belt a second time after the reflection.

The light loses intensity on its light path, and it loses even more intensity when it must pass through the conveyor belt twice. It is clear that light intensity is lost by light absorption in the conveyor belt with each traverse. However, there is also a considerable loss of light intensity from light reflection, and indeed on the surfaces of the conveyor belt with each entry and exit of the light. With a double passage through the conveyor belt, there is thus twice the loss of absorption and even four times the loss of reflection. It can be shown that the portion of the reflection loss in the entire loss of intensity with the traversing of the conveyor belt is greater the more transparent the conveyor belt, meaning that the smaller the optical density of the conveyor belt, i.e., the thinner and/or more transparent the material of the conveyor belt. To be precise, the amount of reflection losses are relatively independent of the optical density of the conveyor belt, and are thus constant, while the absorption losses increase in a linear manner with the optical density of the conveyor belt. In this case, the optical density is determined as follows:

D=−Ig(τₜₒₜₐₗ)

determined with the total transmission

τₜₒₜₐₗ=I/I₀

to the ratio of transmitted light intensity I to the directed light intensity I₀. The standardized total loss can then be calculated by the following:

Vₜₒₜₐₗ=1−τₜₒₜₐₗ.

With the transparent conveyor belts customarily used, which are traversed, in the direction of their surface, normal, and thus vertically, the optical density D is approximately 0.04 to 0.05. This is an area of density in which the reflection losses prevail over the absorption losses, which is roughly the case up to an optical density of 0.062. The reflection losses are thus relatively substantial and cannot be ignored and constitute a light intensity loss of approximately 13% with a customary conveyor belt. Even without any absorption loss, an ideal transparent conveyor belt would have an optical density of at least 0.031 due to the reflection loss alone.

Due to aging and soiling of the conveyor belt as well as of the light barrier, the light intensity loss increases with time. The intensity reached by the light receiver thus constantly decreases, until a perfect detection of an object, or the lack of an object, is no longer ensured.

### SUMMARY OF THE INVENTION

The purpose of this invention is to expediently improve a method or a device, so that a sufficient light intensity reaches the light receiver of the light source for a longer period of time when detecting a sheet to be printed on a transparent conveyor belt in a printing process. Accordingly, the method and device contain a soiling reservoir. The light of the light barrier can be used without considerable reflection losses, so that, despite long-existing aging and spoiling of the translucent area or object and/or light barrier components, a clearly identifiable light intensity difference through a translucent area or object is still provided, even with the dimming of the light barrier.

According to the invention, reflection losses can preferably be prevented, if the light of the light barrier, which shines on the transparent area or object at least approximately under the so-called Brewster (polarizing) angle, is used. The Brewster (polarizing) angle is the angle in which the light portion oscillating parallel to the plane of incidence is not reflected on the surface of an optically dense medium, but is fully refracted into the medium. Thus, with the method according to the invention, the use of the corresponding polarized light is preferably envisaged, in which a suitable polarizer is used and appropriately adjusted. As a result, the extraneous light insensitivity of the method is also increased. However, the use of the Brewster (polarizing) angle with the division of the incident light into a light portion that has been completely refracted into the medium and a reflected portion of light without polarization of the light transmitted by the medium, thus through the more translucent area or object, would result in further transmitted light. In any case, it may actually not be necessary, but advantageous, if an analyzer, as preferably envisaged, is used on the other side of the area or object, in order to prevent the extraneous light in this area as well.

The Brewster (polarizing) angle is Θ_{B}=55.6° with a customary refractive index of the translucent area or object of, for example, n=1.46. Even with an inexact setting of this Brewster (polarizing) angle in the range of ΔΘ_{B}=±5°, the reflection losses of the respective polarized light are only less than approximately 0.25%.

Under certain circumstances, the transmission of polarized light through the translucent area or object is not only determined by the refractive index n of the medium used or the optical density D. In particular, when a transparent conveyor belt made of plastic for a stock in a printing press, this conveyor belt, e.g., due to stresses, may have an individual outstanding major optical axis position with an angle Φ in the plane of the conveyor belt with respect to a selected reference direction. Such a conveyor belt then acts once again as a polarization filter that only allows the vectorial portion of the light, which oscillates parallel to the major axis position, to pass through. In order to prevent the resulting loss of light, it is preferably envisaged according to the invention to align the arrangement with the major axis position by rotation.

A device according to the invention is displayed in an independent solution of the task at hand, in that the beam direction of the light source is set at least approximately at the so-called Brewster (polarizing) angle to the surface of the translucent area or object. This prevents reflection losses at the boundary surfaces or surfaces, as has already been described in detail above in connection with the method according to the invention. Preferably, the light used is polarized with a polarizer and sent through an analyzer to prevent extraneous light influence.

The light barrier used is preferably a transmission-reflection light barrier, in which the light source and the light receiver are arranged on the same side and, as a result, can be combined advantageously as a sensor unit, while on the other side facing the area or object, only a reflector is located, which is an angular mirror or a triple mirror. Here, the angular or roof edge of the angular mirror is preferably aligned with a polarization direction of the light, so that the polarization direction of the light, where possible, is not changed by the reflection.

So that a polarization direction of the light can be focused on an existing major optical axis position of the translucent area or object where necessary, it is envisaged, following a further development of the device according to the invention, that the light barrier can be rotated around its optical axis and/or vertically on the area or object.

The invention and its advantages will be better understood from the ensuing detailed description of preferred embodiments, reference being made to the accompanying drawings in which like reference characters denote like parts.

### BRIEF DESCRIPTION OF THE DRAWINGS

An embodiment of the device according to the invention, to which the scope of the invention is not, however, restricted, is schematically shown in the drawing and explained. Shown are the following:

FIG. 1 is the principal configuration of a typical light detection device from a side view;

FIG. 2 is a graphical representation of the percentage of light intensity loss during the passage through a medium as a function of the optical density of the medium;

FIG. 3 is a graphical representation of the percentage of light intensity loss due to a reflection on the surface of a medium as a function of the incident angle; and

FIG. 4 is the principal configuration of a device according to the invention from a side view.

### DETAILED DESCRIPTION OF THE INVENTION

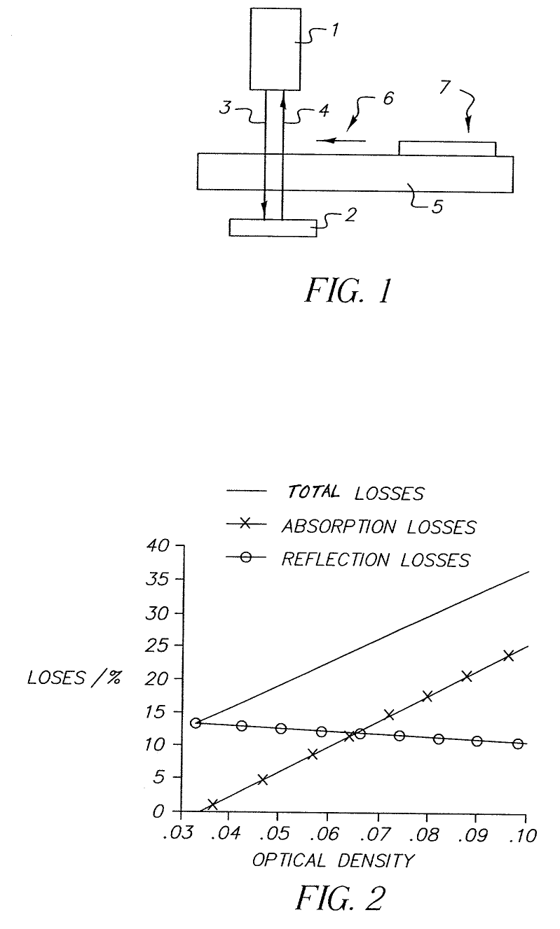

FIG. 1 shows the principal configuration of a light detection device for detecting a sheet to be printed on a transparent conveyor belt in a printing press. This embodiment shows a side view of a light barrier, which comprises a sensor unit 1 and a reflector 2. The sensor unit, which is not shown in further detail, contains a light source that emits a light beam 3 and a light receiver, which again receives a light beam 4 reflected by the reflector 2. The light beam 3 transmitted traverses a translucent area or object 5, which, in the embodiment, should be a section of a transparent conveyor belt that can be moved in a transport direction 6. Following its reflection on the reflector 2, the light beam passes through the object 5 once again as light beam 4. The light 3, 4 loses intensity due to the passage through the object 5 as well as to the absorption of light in object 5 and also because of the reflection losses at the boundary surfaces and the surfaces of the object 5 during the entry and exit of the light beam 3 and during the entry and exit of the light beam 4. The sensor unit 1, in particular the light receiver, is adjusted to this light intensity loss in order to detect that only the translucent object 5 is located in the path of the light barrier 1, 2 and that there is no nondiaphanous or even an opaque object 7, as likewise indicated in FIG. 1. This object 7 should represent a sheet stock or substrate for printing, which is transported in the transport direction 6 through the light barrier on and with the object 5. If object 7 extends into the light path of the light barrier 1, 2, then the latter is refracted, or, if the object 7 is only less translucent than the object 5, then the light will be dimmer than without the object 7. The light receiver must detect this reduction in light intensity, which requires a certain threshold of the intensity difference for a reliable reading.

For example, in the area of a printing press, particularly an electrophotographic printing press, a position location of a sheet to be printed (object 7) can be conducted with such a light barrier, in order to provide the printed work for its illustration and for the printing of the sheet with a corresponding leader during the further transport of the sheet, in order to then perform the printing exactly on time. The arrival of a sheet at the light barrier should thus take place reliably and promptly and lead to a corresponding control signal of the light barrier. Since, however, a or the next sheet is to be expected in the area of the light barrier is to be expected in the printing press at specific time intervals, it may also be important to know if no next sheet arrives at the expected time, but is missing in the area of the light barrier. Over time, however, the existing device ages and/or is soiled, whether it be the components of the light barrier or more likely the object 5. Then, however, object 5 is opaque, at least in some “soiled” areas, so that the light intensity loss in these soiled areas is greater and thus the difference of the light intensity loss and the relatively comparable light intensity loss between a soiled area of object 5 and an object 7 or between an unsoiled area of the object 5 and a soiled area of object 5 is smaller, and even possibly smaller than a threshold value in which the still reliable response of the sensor unit 1 is ensured. An object 7 on an object 5 may thus be falsely detected or a soiling of object 5 may be viewed as object 7. Both cases may lead to serious impairment of or damages to the printing press.

According to the invention, it is thus envisaged making the difference of the light intensity loss through object 5 in comparison with object 7 as large as possible from the outset, in which reflection losses at object 5 can be prevented, in order to have a larger tolerance range and thus more time for a tolerance for soiling without impairing the reliability of the device.

As FIG. 2 clearly shows, the reflection losses in comparison with the absorption losses cannot be ignored. In FIG. 2, the light intensity loss percentages are shown as a function of the optical density. The total loss is reproduced in an unmarked graph, while the absorption loss is shown in a graph marked with crosses and the reflection loss is shown as a graph marked with circles. From FIG. 2, it can be seen that up to an optical density of approximately 0.062, the reflection losses are greater than the absorption losses; that, just because of the reflection loss, already a minimal optical density of approximately 0.031 is reached and that the reflection loss, which is relatively independent of the optical density, remains more or less constant.

Since printing presses with transparent conveyor belts usually operate with an optical density of approximately 0.04 to 0.05, the reflection loss with this type of conveyor belt is considered to be the cause of major loss. According to the invention, prevention of this reflection loss is thus envisaged, whereby linearly polarized light is preferably used and aligned parallel with the plane of incidence in the Brewster (polarizing) angle and directed at the conveyor belt. The device can be connected to a polarizer 1a for the polarization of the light of the sensor unit 1, and an analyzer 2a can be connected in series to the reflector 2, which are shown schematically for the sake of clarity in FIG. 4.

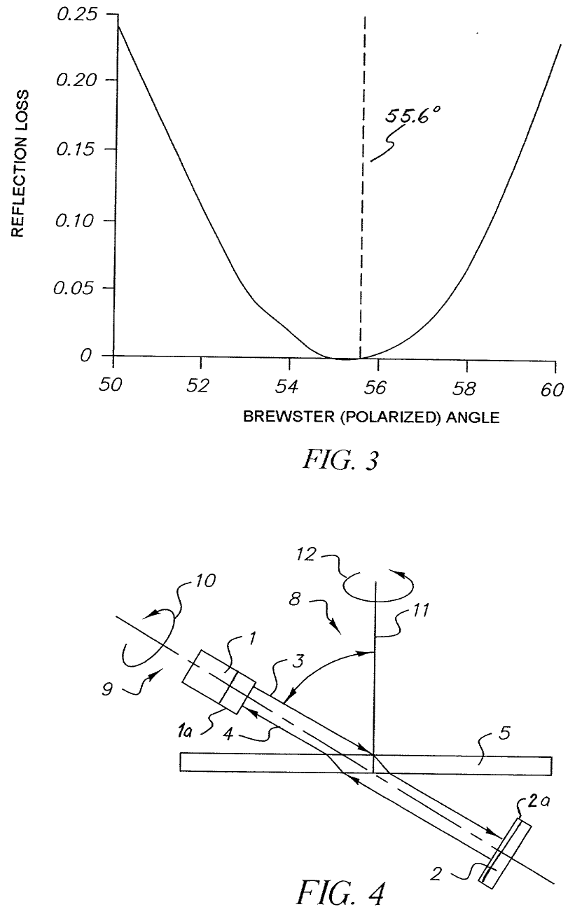

In this case, FIG. 3 shows the percentage of the reflection intensity loss as a function of the incident angle in degrees. With the selected example, in which the refractive index is assumed to be n=1.46, the minimum of the reflection loss with a Brewster (polarizing) angle of 55.6° can be clearly detected, and indeed with a function value of 0.0% reflection loss. Furthermore, it can be seen from FIG. 3 that it is relatively uncritical for the reflection loss, if the Brewster (polarizing) angle is not exactly adjusted, because the reflection loss only very slowly increases to the left and the right of its minimum, so that within the range of the Brewster (polarizing) angle of ±5°, the reflection loss is below 0.25%.

FIG. 4 shows a schematic side view of an exemplary principal configuration of a device according to the invention. The same structural components are designated with the same reference numbers as in FIG. 1.

The device contains light barrier components 1, 2 that work with light beams 3, 4, that are refracted by the transparent object 5. In this case, the light barrier has an optical axis 9, which is aligned at the Brewster incident angle 8 with the surface of the object 5. Since, in addition, the object 5 may have a separate major optical axis position, it is also envisaged that the light barrier can be rotated or swiveled around its axis 9 according to arrow 10 and/or around the vertical line 11 on the surface of the object 5 according to arrow 12 for alignment of the polarization direction of the polarized light 3, 4 parallel to the major axis position. The alignment of the polarization direction may be sensed by analyzer 2a to generate an appropriate feedback signal to adjust the polarizer 1a.

The invention has been described in detail with particular reference to certain preferred embodiments thereof, but it will be understood that variations and modifications can be effected within the spirit and scope of the invention.

What is claimed is:

1. Method for detection or for detection of the lack of an opaque area or object in comparison with a more transparent area or object, preferably for the detection of stock or a substrate on a transparent conveyor belt, by a light barrier characterized in that the reflection loss of the light (3,4) of the light barrier (1, 2) at a translucent area or object (5) is prevented by the use of the light (3,4) of the light barrier (1, 2), which shines at least close under the Brewster (polarizing) angle (8) on the translucent area or object (5).

2. Method according to claim 1, characterized in that polarized light parallel to the plane of incidence is used.

3. Method according to claim 1, characterized in that an analyzer with parallel alignment to the plane of incidence of the light is used.

4. Method according to claim 2, characterized in that, by a suitable rotation (10, 12), at least one Brewster (polarizing) angle induced polarization of the light (3, 4) transmitted by the translucent area or object (5), is set in its direction parallel to any existing major optical axis position of the more translucent area or object (5).

5. Device for the detection or for the detection of a lack of an opaque area or object in comparison with a translucent area or object, preferably for the detection of stock or substrate on a transparent conveyor belt, containing a light barrier with a light source and a light receiver characterized in that the beam direction (optical axis 9) of said light source is set at least approximately at the Brewster (polarizing) angle (8) to the surface of the translucent area or object (5).

6. Device according to claim 5, characterized by a polarizer connected in series behind said light source for the polarization of the light of said light source.

7. Device according to claim 6, characterized by an analyzer connected in series in front of said light receiver.

8. Device according to claim 6, characterized in that said light barrier is a transmission-reflection light barrier (1, 2), in which said light and said light receiver are arranged on one side of the translucent area or object (5) and a light reflector (2) is arranged on the other side of the translucent area or object (5).

9. Device according to claim 8, characterized in that the reflector (2) is an angular mirror.

10. Device according to claim 9, characterized in that the roof edge of said angular mirror is aligned parallel to a polarization direction of said light.

11. Device according to claim 5, characterized in that the components of said light barrier (1, 2) are arranged so that they can rotate around their optical axis (9).

12. Device according to claim 5, characterized in that said light barrier (1, 2) with its optical axis (9) is arranged so that it can rotate around the vertical line (11) to the more translucent area or object (5).
